(19) United States
(12) Patent Application Publication
(10) Pub. No.: US 2025/0342395 A1
(43) Pub. Date: Nov. 6, 2025

(54) MODEL OPTIMIZATION METHODS AND APPARATUSES, DEVICES, AND STORAGE MEDIA

(71) Applicant: Alipay (Hangzhou) Information Technology Co., Ltd., Hangzhou (CN)

(72) Inventors: Weiqiang WANG, Hangzhou (CN); Changhao ZHANG, Hangzhou (CN); Shuheng SHEN, Hangzhou (CN); Xinyi FU, Hangzhou (CN)

(21) Appl. No.: 18/871,625

(22) PCT Filed: Aug. 1, 2023
(86) PCT No.: PCT/CN2023/110635

§ 371 Date: Dec. 4, 2024

(30) Foreign Application Priority Data
Nov. 29, 2022 (CN) 202211508332.1

(51) Int. Cl. G06N 20/00

(52) U.S. Cl. CPC G06N 20/00

(57) ABSTRACT

This specification discloses model optimization methods and apparatuses, devices, and storage media. A model with a low service result accuracy rate can be selected from service models as a target model, and therefore fitting can be performed based on input feature data of the target model and an output result of the target model. Therefore, a weight value corresponding to each feature dimension of the feature data input into the target model can be determined. Further, data of specific feature dimensions of the feature data that are more concerned by the target model can be determined based on the determined weight value corresponding to each feature dimension of the feature data, and the target model is optimized based on feature dimensions concerned by the target model.

### TECHNICAL FIELD

This specification relates to the field of artificial intelligence technologies, and in particular, to model optimization methods and apparatuses, devices, and storage media.

### BACKGROUND

Currently, with development of artificial intelligence technologies, machine learning models are applied in various aspects. For example, an operation of a user is risk-controlled based on user data by using a neural network model, to protect personal privacy data of the user.

However, the machine learning models used in different fields are generally considered as “black boxes”, that is, the user only knows that the machine learning model can obtain an output result based on input data, but does not know how the machine learning model obtains the output result based on the input data. Consequently, further optimization of the machine learning model cannot be performed.

### SUMMARY

This specification provides model optimization methods and apparatuses, devices, and storage media, to partially resolve a problem existing in a related technology.

This specification uses the following technical solutions: This specification provides a model optimization method, including: determining service models required for executing a service; selecting a target model from the service models based on a service result obtained after the service is executed by using the service models in a specified time period; determining candidate feature data used as input data of the target model; selecting target feature data from the candidate feature data, where the target feature data includes several feature dimensions; inputting the target feature data into the target model to obtain an output result corresponding to the target feature data; determining a fitting result based on weights corresponding to the feature dimensions and a feature value corresponding to each feature dimension, and determining, by using a predetermined optimization algorithm, a weight corresponding to each feature dimension, for minimizing a difference between the fitting result and the output result corresponding to the target feature data; and optimizing the target model based on the determined weight corresponding to each feature dimension, and executing the service by using an optimized target model.

Optionally, selecting the target feature data from the candidate feature data specifically includes: for each candidate feature data, inputting the candidate feature data into the target model, to obtain an output result corresponding to the candidate feature data; determining, based on the output result corresponding to the candidate feature data, a degree of impact of the candidate feature data on the target model to obtain the output result, as an impact degree corresponding to the candidate feature data; and selecting the target feature data from the candidate feature data based on the impact degree corresponding to each candidate feature data.

Optionally, inputting the target feature data into the target model to obtain an output result corresponding to the target feature data specifically includes: performing masking processing on feature values corresponding to a part of feature dimensions in the target feature data to obtain masked feature data; and inputting the masked feature data into the target model to obtain an output result corresponding to each masked feature data.

Optionally, determining the fitting result based on weights corresponding to the feature dimensions and a feature value corresponding to each feature dimension, and determining, by using a predetermined optimization algorithm, a weight corresponding to each feature dimension, for minimizing a difference between the fitting result and the output result corresponding to the target feature data specifically includes: for each masked feature data, determining, based on the weights corresponding to the feature dimensions and a feature value corresponding to each feature dimension in the masked feature data, a fitting result corresponding to the masked feature data; and determining a weight corresponding to each feature dimension, for minimizing a difference between the fitting result corresponding to each masked feature data and the output result corresponding to each masked feature data.

Optionally, determining the fitting result based on weights corresponding to the feature dimensions and a feature value corresponding to each feature dimension, and determining, by using a predetermined optimization algorithm, a weight corresponding to each feature dimension, for minimizing a difference between the fitting result and the output result corresponding to the target feature data specifically includes: inputting the target feature data and the output result corresponding to the target feature data into a predetermined weight determining model, so that the weight determining model determines the fitting result based on the weights corresponding to the feature dimensions and the feature value corresponding to each feature dimension, and determines the weight corresponding to each feature dimension, for minimizing the difference between the fitting result and the output result corresponding to the target feature data.

Optionally, determining the fitting result based on weights corresponding to the feature dimensions and a feature value corresponding to each feature dimension, and determining, by using a predetermined optimization algorithm, a weight corresponding to each feature dimension, for minimizing a difference between the fitting result and the output result corresponding to the target feature data specifically includes: determining the fitting result based on the weights corresponding to the feature dimensions and the feature value corresponding to each feature dimension, and determining, by using the predetermined optimization algorithm and based on a correlation between the feature dimensions included in the feature data, the weight corresponding to each feature dimension, for minimizing the difference between the fitting result and the output result corresponding to the target feature data.

This specification provides a model optimization apparatus, including: a first determining module, configured to determine service models required for executing a service; a first selection module, configured to select a target model from the service models based on a service result obtained after the service is executed by using the service models in a specified time period; a second determining module, configured to determine candidate feature data used as input data of the target model; a second selection module, configured to select target feature data from the candidate feature data, where the target feature data includes several feature dimensions; an acquisition module, configured to input the target feature data into the target model to obtain an output result corresponding to the target feature data; a weight determining module, configured to: determine a fitting result based on weights corresponding to the feature dimensions and a feature value corresponding to each feature dimension, and determine, by using a predetermined optimization algorithm, a weight corresponding to each feature dimension, for minimizing a difference between the fitting result and the output result corresponding to the target feature data; and an optimization module, configured to: optimize the target model based on the determined weight corresponding to each feature dimension, and execute the service by using an optimized target model.

Optionally, the second selection module is specifically configured to: for each candidate feature data, input the candidate feature data into the target model, to obtain an output result corresponding to the candidate feature data; determine, based on the output result corresponding to the candidate feature data, a degree of impact of the candidate feature data on the target model to obtain the output result, as an impact degree corresponding to the candidate feature data; and select the target feature data from the candidate feature data based on the impact degree corresponding to each candidate feature data.

This specification provides a computer-readable storage medium. The storage medium stores a computer program, and when the computer program is executed by a processor, the model optimization method is implemented.

This specification provides an electronic device, including a memory, a processor, and a computer program that is stored in the memory and that is capable of running on the processor. When the processor executes the program, the model optimization method is implemented.

The above-mentioned at least one technical solution used in this specification can achieve the following beneficial effects: In the model optimization method provided in this specification, service models required for executing a service are first determined; a target model is selected from the service models based on a service result obtained after the service is executed by using the service models in a specified time period; candidate feature data used as input data of the target model are determined; target feature data are selected from the candidate feature data, where the target feature data includes several feature dimensions; the target feature data are input into the target model to obtain an output result corresponding to the target feature data; a fitting result is determined based on weights corresponding to the feature dimensions and a feature value corresponding to each feature dimension, and a weight corresponding to each feature dimension is determined by using a predetermined optimization algorithm, for minimizing a difference between the fitting result and the output result corresponding to the target feature data; and the target model is optimized based on the determined weight corresponding to each feature dimension, and the service is executed by using an optimized target model.

It can be learned from the above-mentioned method that, a model with a low service result accuracy rate can be selected from service models as a target model, and therefore fitting can be performed based on input feature data of the target model and an output result of the target model. Therefore, a weight value corresponding to each feature dimension of the feature data input into the target model can be determined. Further, data of specific feature dimensions of the feature data that are more concerned by the target model can be determined based on the determined weight value corresponding to each feature dimension of the feature data, and the target model is optimized based on feature dimensions concerned by the target model.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification. In the accompanying drawings:

FIG. 1 is a schematic flowchart illustrating a model optimization method, according to this specification;

FIG. 2 is a diagram illustrating feature data, according to this specification;

FIG. 3 is a diagram illustrating a model optimization apparatus, according to this specification; and

FIG. 4 is a diagram illustrating an electronic device corresponding to FIG. 1, according to this specification.

### DESCRIPTION OF EMBODIMENTS

To make the objectives, technical solutions, and advantages of this specification clearer, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on embodiments of this specification without creative efforts shall fall within the protection scope of this specification.

The following describes in detail the technical solutions provided in the embodiments of this specification with reference to the accompanying drawings.

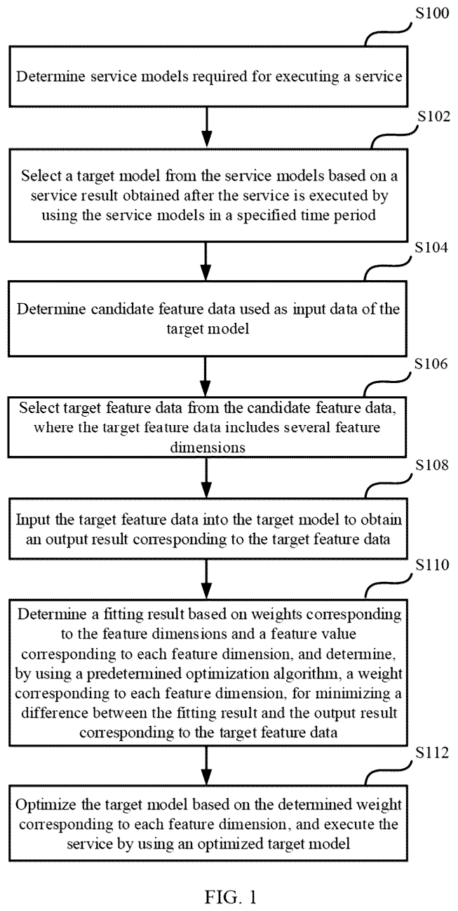

FIG. 1 is a schematic flowchart illustrating a model optimization method, according to this specification, including the following steps S100 to S112.
S100: Determine service models required for executing a service.
S102: Select a target model from the service models based on a service result obtained after the service is executed by using the service models in a specified time period.

In this specification, a server of a service platform can select, from the service models as the target model, a service model that needs to be optimized, so as to optimize the target model.

Specifically, the server of the service platform can select the target model from the service models based on the service result obtained after the service is executed by using the service models in the specified time period. For example, a model with a low service result accuracy rate obtained after the service is executed is selected from the service models as the target model.

In this specification, an execution body for implementing the model optimization method can be a specified device disposed on the service platform like the server, or can be a terminal device like a desktop computer or a notebook computer. For ease of description, the following uses only an example in which the server is an execution body to describe the model optimization method provided in the specification.
S104: Determine candidate feature data used as input data of the target model.
S106: Select target feature data from the candidate feature data, where the target feature data includes several feature dimensions.

In this specification, the server of the service platform can obtain feature data input into the target model, and use the feature data as the candidate feature data to optimize the target model based on the candidate feature data input into the target model. The feature data input into the target model here can be, for example, feature data corresponding to a service behavior of a user at different times, or feature data corresponding to an account status of the user at different times.

Further, different candidate feature data have different degrees of impact on the target model to obtain an output result. Therefore, the server of the service platform can further perform screening on the candidate feature data to select, as the target feature data, candidate feature data having a high degree of impact on the target model to obtain the output result, and can further optimize the target model based on the target feature data. Different candidate feature data here are feature data with different value categories, for example, feature data corresponding to a service behavior of the user and feature data corresponding to an account status of the user are feature data of different categories.

Specifically, for each candidate feature data, the server of the service platform can input the candidate feature data into the target model, to obtain an output result corresponding to the candidate feature data, and determine, based on the output result corresponding to the candidate feature data, a degree of impact of the candidate feature data on the target model to obtain the output result, as an impact degree corresponding to the candidate feature data, so as to select the target feature data from the candidate feature data based on the impact degree corresponding to each candidate feature data.

In addition, in the field like account risk control, a neural network model usually needs to perform account risk control on an account of the user based on feature values of the user in the past month or even one year. However, in the feature values of the user in the past month or even one year, only a small part of the feature values can have a great impact on an output result of the neural network model. Therefore, it can be learned that in the field like account risk control, the target feature data input into the neural network model include sparse feature values having a high degree of impact.

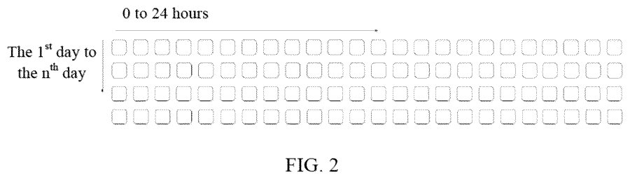

Therefore, the server of the service platform can aggregate the feature values in the obtained feature data based on a specified feature dimension, to obtain feature values corresponding to feature dimensions, and can further determine a weight corresponding to each feature dimension, to effectively reduce a calculation amount. The specified feature dimension here can refer to a dimension like a time or a region. For example, the specified feature dimension is the time. The server of the service platform can aggregate the feature values in the feature data of the user in units of hours, as shown in FIG. 2.

FIG. 2 is a diagram illustrating feature data, according to this specification.

It can be learned from FIG. 2 that the server of the service platform can aggregate the feature values in the feature data of the user by hour, and use a feature value that belongs to a same hour in the feature data as a feature value corresponding to a feature dimension. One block in FIG. 2 is a feature value corresponding to a feature dimension. A block in each column corresponds to each hour of a day, and a block in each row corresponds to each day.

For example, the feature data of the user are data of a behavior feature of the user. The above-mentioned feature data refer to feature values corresponding to all service behaviors of the user within one month. The above-mentioned feature values are values. A feature representation obtained after feature extraction is performed on any service behavior of the user within one month is one feature value. Therefore, the target feature data includes a plurality of feature values in several feature dimensions.
S108: Input the target feature data into the target model to obtain an output result corresponding to the target feature data.

The server can perform masking processing on feature values corresponding to a part of feature dimensions in the target feature data to obtain masked feature data, and input the masked feature data into the target model to obtain an output result corresponding to each masked feature data.

Specifically, the server can perform, based on different masking policies, masking processing on the feature values corresponding to the part of feature dimensions in the target feature data to obtain the masked feature data. The server obtains one masked feature data after performing masking processing on the target feature data based on any masking policy.

For example, it is assumed that the target feature data of the user are feature data corresponding to a service behavior of the user within a day. It can be learned from the above-mentioned content that, the server can divide a feature value corresponding to each service behavior of the user within a day into feature values of 24 feature dimensions by hour, and can further perform masking on data of some feature dimensions in data of the 24 feature dimensions, for example, perform masking on feature values corresponding to two feature dimensions, namely, 3 p.m. and 5 p.m., to obtain one masked feature data.

Each time the server performs masking processing on the target feature data, masked data are different. Therefore, each masked feature data includes different feature dimensions that are not masked. Therefore, a weight corresponding to each feature dimension in the target feature data can be determined based on the output result corresponding to each masked feature data.
S110: Determine a fitting result based on weights corresponding to the feature dimensions and a feature value corresponding to each feature dimension, and determine, by using a predetermined optimization algorithm, a weight corresponding to each feature dimension, for minimizing a difference between the fitting result and the output result corresponding to the target feature data.

Further, for each masked feature data, the server can determine, based on the weights corresponding to the feature dimensions and a feature value corresponding to each feature dimension in the masked feature data, a fitting result corresponding to the masked feature data, and determine a weight corresponding to each feature dimension, for minimizing a difference between the fitting result corresponding to each masked feature data and the output result corresponding to each masked feature data.

Specifically, the server can input the masked feature data and output results corresponding to the masked feature data into a predetermined weight determining model, so that the weight determining model determines, based on the weights corresponding to the feature dimensions and the feature value corresponding to each feature dimension in the masked feature data, the fitting result corresponding to the masked feature data, and determines the weight corresponding to each feature dimension, for minimizing the difference between the fitting result corresponding to each masked feature data and the output result corresponding to each masked feature data.

The method for the server to determine, by using the predetermined weight determining model, the weight corresponding to each feature dimension, for minimizing the difference between the fitting result and the output result corresponding to the target feature data can be determining, by using a maximum likelihood estimation algorithm, the weight corresponding to each feature dimension, for infinitely approaching the fitting result determined based on the weights corresponding to the feature dimensions and the feature value corresponding to each feature dimension to the output result corresponding to the target feature data.

In addition, the server can determine, by using the predetermined weight determining model, an initial weight corresponding to each feature dimension in the target feature data, and can further determine, by using several rounds of iterations, the weight corresponding to each feature dimension in the target feature data.

For each round of iteration, a weight fitting model can determine a to-be-optimized weight corresponding to each feature dimension in the target feature data in the round of iteration, can further predict, based on the to-be-optimized weight corresponding to each feature dimension in the target feature data, a probability value of the feature value corresponding to each feature dimension belonging to predetermined Gaussian distributions, and can further re-estimate, based on the predicted probability value of the feature value corresponding to each feature dimension belonging to predetermined Gaussian distributions and the output result corresponding to each masked feature data in the target model, a to-be-optimized weight corresponding to each feature dimension in the target feature data. The to-be-optimized weight corresponding to each feature dimension in the target feature data in the round of iteration is obtained by iterating the initial weight to a previous iteration, and the weight corresponding to each feature dimension in the target feature data is obtained after it is determined that a predetermined iteration termination condition is met.

In the above-mentioned content, a quantity of predetermined Gaussian distributions can be determined based on an actual need.

In the above-mentioned content, the predetermined iteration termination condition can be, for example, the predetermined Gaussian distributions converge, that is, the predicted probability value of the feature value corresponding to each feature dimension belonging to predetermined Gaussian distributions does not change, or a quantity of iterations reaches a predetermined threshold.

In the above-mentioned content, the method for the weight fitting model to re-estimate, based on the predicted probability value of the feature value corresponding to each feature dimension belonging to predetermined Gaussian distributions and the output result corresponding to each masked feature data in the target model, the to-be-optimized weight corresponding to each feature dimension in the target feature data can be calculating, by using the maximum likelihood estimation algorithm, the to-be-optimized weight corresponding to each feature dimension in the target feature data.

It can be learned from the above-mentioned content that each feature dimension in the target feature data can be considered as an independent individual by the server, that is, feature dimensions are independent of each other, so that the weight corresponding to each feature dimension can be accurately determined. However, when some feature dimensions are closely correlated with another feature dimension, that is, when a feature value corresponding to the feature dimension is considered separately, a degree of impact of the feature value corresponding to the feature dimension on the target model to obtain an output result is not reflected. Therefore, when the feature dimension is considered as an independent individual, a weight corresponding to the feature dimension is not large. When the feature value corresponding to the feature dimension is combined with a feature value corresponding to another feature dimension, a degree of impact of a feature value corresponding to the two feature dimensions on the target model to obtain an output result is high.

For example, it is assumed that there is a large difference between a service behavior of the user at 5 p.m. on Friday and behavior feature data of the user at 5 p.m. on Monday to Thursday (for example, the user has a small transaction at 5 p.m. on Monday to Thursday, and suddenly has a large transaction at 5 p.m. on Friday), and the difference can be reflected when feature values corresponding to feature dimensions of the user at 5 p.m. on Monday to Friday are integrally considered as an independent individual. The target model can determine, based on the individual, that the service behavior of the user at 5 p.m. on Friday is abnormal. If behavior feature data of the user at 5 p.m. on Friday are separately considered as an individual, the target model cannot determine, based on the individual, whether the behavior feature of the user at 5 p.m. on Friday is abnormal. Therefore, a weight obtained when the feature values corresponding to the feature dimensions of the user at 5 p.m. on Monday to Friday are integrally considered as an independent individual is larger than a weight obtained when each of the feature values corresponding to the feature dimensions of the user at 5 p.m. on Monday to Friday is considered as an independent individual.

For another example, from 3 p.m. to 5 p.m., a plurality of login account failure records of the user occur in the three consecutive hours, which may indicate that the user forgets the login password after replacing the mobile phone. Therefore, there is a large difference between a weight obtained when the plurality of login account failure records occurred in the three consecutive hours from 3 p.m. to 5 p.m. are integrally considered as an individual and a weight obtained when each of the plurality of login account failure records occurred in the three consecutive hours from 3 p.m. to 5 p.m. is considered as an individual.

Based on this, the server can determine the fitting result based on the weights corresponding to the feature dimensions and the feature value corresponding to each feature dimension, and determine, by using the predetermined optimization algorithm and based on a correlation between each feature dimensions included in the feature data, the weight corresponding to each feature dimension, for minimizing the difference between the fitting result and the output result corresponding to the target feature data.

The correlation between the feature dimensions can be predetermined. The weight model can group, based on the predetermined correlation between the feature dimensions, feature dimensions having a correlation into feature dimension combinations, can further determine a fitting result based on a weight corresponding to each feature dimension and/or each feature dimension combination and a feature value corresponding to each feature dimension and/or each feature dimension combination, and can determine, by using the predetermined optimization algorithm, a weight corresponding to each feature dimension and/or each feature dimension combination, for minimizing the difference between the fitting result and the output result corresponding to the target feature data.

Notably, for each feature dimension combination, feature dimensions in the feature dimension combination limit, by using Fused Lasso in the above-mentioned fitting process, a difference between weight values corresponding to feature dimensions that have a correlation and that are included in the feature dimension combination, so that the difference between weight values corresponding to feature dimensions that have a correlation and that are included in the feature dimension combination is within a predetermined small threshold. Therefore, the above-mentioned grouping feature dimensions having a correlation into feature dimension combinations is implemented.
S112: Optimize the target model based on the determined weight corresponding to each feature dimension, and execute the service by using an optimized target model.

In this specification, the server can determine the weight corresponding to each feature dimension in the target feature data, optimize the target model, and execute a corresponding service by using the optimized target model.

The service corresponding to the optimized target model can be, for example, performing risk monitoring on a service behavior of the user based on data corresponding to an input user service behavior.

It can be learned from the above-mentioned content that, the server can determine the weight corresponding to each feature dimension and/or each feature dimension combination in the target feature data, and determine feature values that correspond to specific feature dimensions and/or feature dimension combinations in the target feature data and mainly based on which the target model obtains an output result, to optimize sample data for training the target model and a structure of the target model.

Notably, service risk control in an actual application is complex, and to ensure effectiveness of the service risk control, a risk control model in the service risk control needs to be continuously optimized, so that an optimized model can adapt to various constantly changing risk control environments in the service risk control.

Therefore, the model optimization method provided in this specification can be used to optimize a risk control model used in service risk control. Therefore, the server can first determine various risk control models used in a service execution process (the risk control model here is the above-mentioned service model). Then, the server can determine the target model from the risk control models based on a risk control result obtained after a risk control service is executed by using various risk control models in a specified time period.

The server can specifically determine, based on a risk control result of executing the risk control service by using various risk control models collected in a specified time period and a risk situation actually encountered by the user, a risk control model with a poor risk control effect as the target model. Then, the server can select the target feature data from the determined candidate feature data, and input the target feature data into the target model to obtain the output result. In a service risk control scenario, feature data can be feature data corresponding to a service record of a service executed by a user, feature data corresponding to geographical information obtained when the user executes a service, feature data corresponding to time information obtained when the user executes a service, feature data corresponding to a transaction amount obtained when the user executes a transaction service, etc.

The server can determine the fitting result based on the weights corresponding to the feature dimensions and the feature value corresponding to each feature dimension, and determine, by using the predetermined optimization algorithm, the weight corresponding to each feature dimension, for minimizing the difference between the fitting result and the output result corresponding to the target feature data.

The server can determine, based on the determined weight corresponding to each feature dimension, specific data that are more concerned by the target model when the target model performs the risk control service, and further optimizes the target model based on an actual risk control need. In this way, a risk control effect of an optimized risk control model can be significantly improved, and a capability of active risk control prevention and control can be improved.

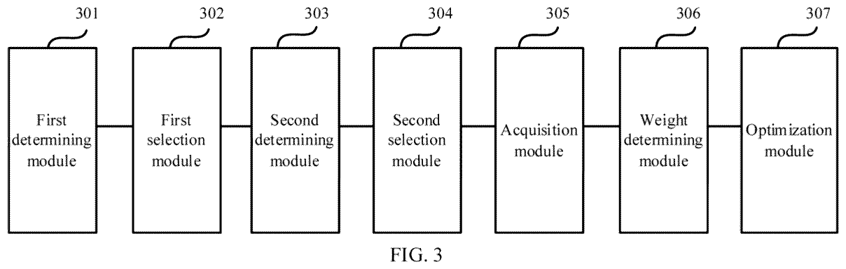

The model optimization method provided in one or more embodiments of this specification is described above. Based on the same idea, this specification further provides a corresponding model optimization apparatus, as shown in FIG. 3.

FIG. 3 is a diagram of a model optimization apparatus, according to this specification, including: a first determining module 301, configured to determine service models required for executing a service; a first selection module 302, configured to select a target model from the service models based on a service result obtained after the service is executed by using the service models in a specified time period; a second determining module 303, configured to determine candidate feature data used as input data of the target model; a second selection module 304, configured to select target feature data from the candidate feature data, where the target feature data includes several feature dimensions; an acquisition module 305, configured to input the target feature data into the target model to obtain an output result corresponding to the target feature data; a weight determining module 306, configured to: determine a fitting result based on weights corresponding to the feature dimensions and a feature value corresponding to each feature dimension, and determine, by using a predetermined optimization algorithm, a weight corresponding to each feature dimension, for minimizing a difference between the fitting result and the output result corresponding to the target feature data; and an optimization module 307, configured to: optimize the target model based on the determined weight corresponding to each feature dimension, and execute the service by using an optimized target model.

Optionally, the second selection module 304 is specifically configured to: for each candidate feature data, input the candidate feature data into the target model, to obtain an output result corresponding to the candidate feature data; determine, based on the output result corresponding to the candidate feature data, a degree of impact of the candidate feature data on the target model to obtain the output result, as an impact degree corresponding to the candidate feature data; and select the target feature data from the candidate feature data based on the impact degree corresponding to each candidate feature data.

Optionally, the acquisition module 305 is specifically configured to: perform masking processing on feature values corresponding to a part of feature dimensions in the target feature data to obtain masked feature data; and input the masked feature data into the target model to obtain an output result corresponding to each masked feature data.

Optionally, the weight determining module 306 is specifically configured to: for each masked feature data, determine, based on the weights corresponding to the feature dimensions and a feature value corresponding to each feature dimension in the masked feature data, a fitting result corresponding to the masked feature data; and determine a weight corresponding to each feature dimension, for minimizing a difference between the fitting result corresponding to each masked feature data and the output result corresponding to each masked feature data.

Optionally, the weight determining module 306 is specifically configured to input the target feature data and the output result corresponding to the target feature data into a predetermined weight determining model, so that the weight determining model determines the fitting result based on the weights corresponding to the feature dimensions and the feature value corresponding to each feature dimension, and determines the weight corresponding to each feature dimension, for minimizing the difference between the fitting result and the output result corresponding to the target feature data.

Optionally, the weight determining module 306 is specifically configured to: determine the fitting result based on the weights corresponding to the feature dimensions and the feature value corresponding to each feature dimension, and determine, by using the predetermined optimization algorithm and based on a correlation between the feature dimensions included in the feature data, the weight corresponding to each feature dimension, for minimizing the difference between the fitting result and the output result corresponding to the target feature data.

This specification further provides a computer-readable storage medium. The storage medium stores a computer program, and the computer program can be used to perform the model optimization method provided in FIG. 1.

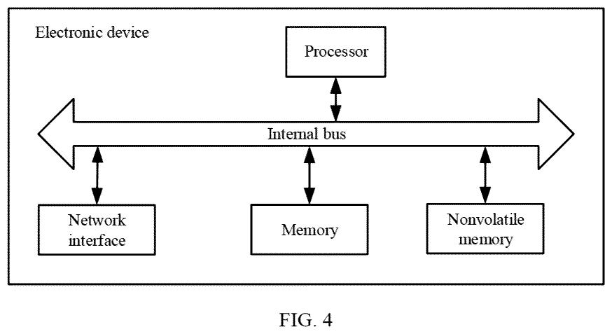

This specification further provides a structural diagram illustrating an electronic device corresponding to FIG. 1, as shown in FIG. 4. As shown in FIG. 4, in terms of hardware, the electronic device includes a processor, an internal bus, a network interface, a memory, and a nonvolatile memory, and certainly may further include hardware needed by another service. The processor reads a corresponding computer program from the nonvolatile memory into the memory and then runs the computer program, to implement the model optimization method in FIG. 1. Certainly, in addition to software implementations, another implementation is not excluded in this specification, for example, a logic device or a combination of hardware and software. In other words, an execution body of the following processing process is not limited to logical units, and can be hardware or a logic device.

In the 1990s, whether a technical improvement is a hardware improvement (for example, an improvement to a circuit structure, like a diode, a transistor, or a switch) or a software improvement (an improvement to a method procedure) can be clearly distinguished. However, with development of technologies, an improvement to many existing method procedures can be considered as a direct improvement to hardware circuit structures. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, instead of making an integrated circuit chip manually today, this programming is mostly implemented by using “logic compiler” software. It is similar to the software compiler used in program development and writing. The original code to be compiled before is also written in a specific programming language. This is referred to as a hardware description language (HDL), and HDL is not only one, but also many, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, and RHDL (Ruby Hardware Description Language). Currently, VHDL (Very-High-Speed Integrated Circuit Hardware Description Language) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented in any suitable way. For example, the controller can be in a form like a microprocessor, a processor, or a computer-readable medium, a logic gate, a switch, an application-specific integrated circuit (ASIC), a programmable logic controller, or an embedded microcontroller storing computer-readable program code (for example, software or firmware) that can be executed by the (micro) processor. Examples of the controller include but are not limited to the following microcontrollers: ARC 625D, Atmel AT91SAM, Microchip PIC18F26K20, and Silicone Labs C8051F320. A storage controller can also be implemented as a part of control logic of the storage. A person skilled in the art also knows that in addition to implementing the controller by using only the computer-readable program code, logic programming can be performed on method steps to enable the controller to implement the same function in a form of a logic gate, a switch, an application-specific integrated circuit, a programmable logic controller, or an embedded microcontroller. Therefore, the controller can be considered as a hardware component, and an apparatus configured to implement various functions in the controller can also be considered as a structure in the hardware component. Alternatively, an apparatus configured to implement various functions can be considered as a software module implementing a method or a structure in a hardware component.

The systems, apparatuses, modules, or units described in the above-mentioned embodiments can be specifically implemented by a computer chip or an entity, or can be implemented by a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of this specification, functions of units can be implemented in the same or more software or hardware.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk storage, a CD-ROM, an optical storage, etc.) that include computer-usable program code can be used in this specification.

This specification is described with reference to a flowchart and/or block diagram of a method, a device (system), and a computer program product according to embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more procedures in the flowcharts and/or in one or more blocks in the block diagrams.

These computer program instructions can also be stored in a computer-readable memory that can indicate a computer or another programmable data processing device to work in a specific way, so that an instruction stored in the computer-readable memory generates a manufacturer including an instruction apparatus, and the instruction apparatus implements a function specified in one or more procedures of a flowchart and/or one or more blocks of a block diagram.

The computer program instructions can alternatively be loaded onto a computer or another programmable data processing device, so that a series of operations and steps are performed on the computer or the another programmable device to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory may include a form like a non-permanent memory, a random access memory (RAM), or a nonvolatile memory in a computer-readable medium, for example, a read-only memory (ROM) or a flash memory (flash RAM). The memory is an example of the computer-readable medium.

Computer-readable media, including permanent and non-permanent, removable and non-removable media, can be implemented by any method or technology for information storage. The information can be computer-readable instructions, a data structure, a program module, or other data. Examples of the computer storage medium include but are not limited to a phase change random access memory (PRAM), a static random access memory (SPAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

It should be further noted that the terms “include”, “comprise”, or any other variants are intended to cover a non-exclusive inclusion, so that a process, a method, a product, or a device that includes a list of elements not only includes those elements but also includes other elements that are not expressly listed, or further includes elements inherent to such s process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, a form of hardware only embodiments, software only embodiments, or embodiments with a combination of software and hardware can be used in this specification. In addition, a form of a computer program product that is implemented on one or more computer-usable storage media (including but not limited to a disk storage, a CD-ROM, an optical storage, etc.) that include computer-usable program code can be used in this specification.

This specification can be described in a general context of computer-executable instructions executed by a computer, for example, a program module. Generally, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environments, a program module can be located in local and remote computer storage media including a storage device.

The embodiments of this specification are described in a progressive way. For same or similar parts in the embodiments, refer to each other. Each embodiment focuses on a difference from other embodiments. Particularly, the system embodiment is basically similar to the method embodiment, and therefore is briefly described. For a related part, refer to some descriptions in the method embodiment.

The foregoing is merely embodiments of this specification, and is not intended to limit this specification. A person skilled in the art can make various changes and variations to this specification. Any modification, equivalent replacement, or improvement made without departing from the spirit and principle of this specification shall fall within the scope of the claims in this specification.

1. A model optimization method, comprising:
determining service models required for executing a service;
selecting a target model from the service models based on a service result obtained after the service is executed by using the service models in a specified time period;
determining candidate feature data used as input data of the target model;
selecting target feature data from the candidate feature data, wherein the target feature data comprises several feature dimensions;
inputting the target feature data into the target model to obtain an output result corresponding to the target feature data;
determining a fitting result based on weights corresponding to the feature dimensions and a feature value corresponding to each feature dimension, and determining, by using a predetermined optimization algorithm, a weight corresponding to each feature dimension, for minimizing a difference between the fitting result and the output result corresponding to the target feature data; and
optimizing the target model based on the determined weight corresponding to each feature dimension, and executing the service by using an optimized target model.

2. The method according to claim 1, wherein selecting the target feature data from the candidate feature data comprises:
for each candidate feature data, inputting the candidate feature data into the target model, to obtain an output result corresponding to the candidate feature data;
determining, based on the output result corresponding to the candidate feature data, a degree of impact of the candidate feature data on the target model to obtain the output result, as an impact degree corresponding to the candidate feature data; and
selecting the target feature data from the candidate feature data based on the impact degree corresponding to each candidate feature data.

3. The method according to claim 1, wherein inputting the target feature data into the target model to obtain an output result corresponding to the target feature data comprises:
performing masking processing on feature values corresponding to a part of feature dimensions in the target feature data to obtain masked feature data; and
inputting the masked feature data into the target model to obtain an output result corresponding to each masked feature data.

4. The method according to claim 3, wherein determining the fitting result based on weights corresponding to the feature dimensions and the feature value corresponding to each feature dimension, and determining, by using the predetermined optimization algorithm, a weight corresponding to each feature dimension, for minimizing a difference between the fitting result and the output result corresponding to the target feature data comprises:
for each masked feature data, determining, based on the weights corresponding to the feature dimensions and the feature value corresponding to each feature dimension in the masked feature data, a fitting result corresponding to the masked feature data; and
determining a weight corresponding to each feature dimension, for minimizing a difference between the fitting result corresponding to each masked feature data and the output result corresponding to each masked feature data.

5. The method according to claim 1, wherein determining the fitting result based on weights corresponding to the feature dimensions and the feature value corresponding to each feature dimension, and determining, by using the predetermined optimization algorithm, a weight corresponding to each feature dimension, for minimizing a difference between the fitting result and the output result corresponding to the target feature data comprises:
inputting the target feature data and the output result corresponding to the target feature data into a predetermined weight determining model, so that the weight determining model determines the fitting result based on the weights corresponding to the feature dimensions and the feature value corresponding to each feature dimension, and determines the weight corresponding to each feature dimension, for minimizing the difference between the fitting result and the output result corresponding to the target feature data.

6. The method according to claim 1, wherein determining the fitting result based on weights corresponding to the feature dimensions and the feature value corresponding to each feature dimension, and determining, by using the predetermined optimization algorithm, a weight corresponding to each feature dimension, for minimizing a difference between the fitting result and the output result corresponding to the target feature data comprises:
determining the fitting result based on the weights corresponding to the feature dimensions and the feature value corresponding to each feature dimension, and determining, by using the predetermined optimization algorithm and based on a correlation between each feature dimensions comprised in the feature data, the weight corresponding to each feature dimension, for minimizing the difference between the fitting result and the output result corresponding to the target feature data.

7-8. (Canceled)

9. A non-transitory computer-readable storage medium, wherein the non-transitory computer-readable storage medium stores a computer program, which when executed by a processor causes the processor to:
determine service models required for executing a service;
select a target model from the service models based on a service result obtained after the service is executed by using the service models in a specified time period;
determine candidate feature data used as input data of the target model;
select target feature data from the candidate feature data, wherein the target feature data comprises several feature dimensions;
input the target feature data into the target model to obtain an output result corresponding to the target feature data;
determine a fitting result based on weights corresponding to the feature dimensions and a feature value corresponding to each feature dimension, and determine, by using a predetermined optimization algorithm, a weight corresponding to each feature dimension, for minimizing a difference between the fitting result and the output result corresponding to the target feature data; and
optimize the target model based on the determined weight corresponding to each feature dimension, and execute the service by using an optimized target model.

10. An electronic device, comprising a memory, a processor, and a computer program that is stored in the memory and that is capable of running on the processor, wherein when the processor executes the program, the electronic device is caused to:
determine service models required for executing a service;
select a target model from the service models based on a service result obtained after the service is executed by using the service models in a specified time period;
determine candidate feature data used as input data of the target model;
select target feature data from the candidate feature data, wherein the target feature data comprises several feature dimensions;
input the target feature data into the target model to obtain an output result corresponding to the target feature data;
determine a fitting result based on weights corresponding to the feature dimensions and a feature value corresponding to each feature dimension, and determine, by using a predetermined optimization algorithm, a weight corresponding to each feature dimension, for minimizing a difference between the fitting result and the output result corresponding to the target feature data; and
optimize the target model based on the determined weight corresponding to each feature dimension, and execute the service by using an optimized target model.

11. The electronic device according to claim 10, wherein the electronic device being caused to select the target feature data from the candidate feature data comprises being caused to:
for each candidate feature data, input the candidate feature data into the target model, to obtain an output result corresponding to the candidate feature data;
determine, based on the output result corresponding to the candidate feature data, a degree of impact of the candidate feature data on the target model to obtain the output result, as an impact degree corresponding to the candidate feature data; and
select the target feature data from the candidate feature data based on the impact degree corresponding to each candidate feature data.

12. The electronic device according to claim 10, wherein the electronic device being caused to input the target feature data into the target model to obtain an output result corresponding to the target feature data comprises being caused to:
perform masking processing on feature values corresponding to a part of feature dimensions in the target feature data to obtain masked feature data; and
input the masked feature data into the target model to obtain an output result corresponding to each masked feature data.

13. The electronic device according to claim 12, wherein the electronic device being caused to determine the fitting result based on weights corresponding to the feature dimensions and the feature value corresponding to each feature dimension, and determine, by using the predetermined optimization algorithm, a weight corresponding to each feature dimension, for minimizing a difference between the fitting result and the output result corresponding to the target feature data comprises being caused to:
for each masked feature data, determine, based on the weights corresponding to the feature dimensions and the feature value corresponding to each feature dimension in the masked feature data, a fitting result corresponding to the masked feature data; and
determine a weight corresponding to each feature dimension, for minimizing a difference between the fitting result corresponding to each masked feature data and the output result corresponding to each masked feature data.

14. The electronic device according to claim 10, wherein the electronic device being caused to determine the fitting result based on weights corresponding to the feature dimensions and the feature value corresponding to each feature dimension, and determine, by using the predetermined optimization algorithm, a weight corresponding to each feature dimension, for minimizing a difference between the fitting result and the output result corresponding to the target feature data comprises being caused to:
input the target feature data and the output result corresponding to the target feature data into a predetermined weight determining model, so that the weight determining model determines the fitting result based on the weights corresponding to the feature dimensions and the feature value corresponding to each feature dimension, and determines the weight corresponding to each feature dimension, for minimizing the difference between the fitting result and the output result corresponding to the target feature data.

15. The electronic device according to claim 10, wherein the electronic device being caused to determine the fitting result based on weights corresponding to the feature dimensions and the feature value corresponding to each feature dimension, and determine, by using the predetermined optimization algorithm, a weight corresponding to each feature dimension, for minimizing a difference between the fitting result and the output result corresponding to the target feature data comprises being caused to:
determine the fitting result based on the weights corresponding to the feature dimensions and the feature value corresponding to each feature dimension, and determine, by using the predetermined optimization algorithm and based on a correlation between each feature dimensions comprised in the feature data, the weight corresponding to each feature dimension, for minimizing the difference between the fitting result and the output result corresponding to the target feature data.

16. The non-transitory computer-readable storage medium according to claim 9, wherein the processor being caused to select the target feature data from the candidate feature data comprises being caused to:
for each candidate feature data, input the candidate feature data into the target model, to obtain an output result corresponding to the candidate feature data;
determine, based on the output result corresponding to the candidate feature data, a degree of impact of the candidate feature data on the target model to obtain the output result, as an impact degree corresponding to the candidate feature data; and
select the target feature data from the candidate feature data based on the impact degree corresponding to each candidate feature data.

17. The non-transitory computer-readable storage medium according to claim 9, wherein the processor being caused to input the target feature data into the target model to obtain an output result corresponding to the target feature data comprises being caused to:
perform masking processing on feature values corresponding to a part of feature dimensions in the target feature data to obtain masked feature data; and
input the masked feature data into the target model to obtain an output result corresponding to each masked feature data.

18. The non-transitory computer-readable storage medium according to claim 17, wherein the processor being caused to determine the fitting result based on weights corresponding to the feature dimensions and the feature value corresponding to each feature dimension, and determine, by using the predetermined optimization algorithm, a weight corresponding to each feature dimension, for minimizing a difference between the fitting result and the output result corresponding to the target feature data comprises being caused to:
for each masked feature data, determine, based on the weights corresponding to the feature dimensions and the feature value corresponding to each feature dimension in the masked feature data, a fitting result corresponding to the masked feature data; and
determine a weight corresponding to each feature dimension, for minimizing a difference between the fitting result corresponding to each masked feature data and the output result corresponding to each masked feature data.

19. The non-transitory computer-readable storage medium according to claim 9, wherein the processor being caused to determine the fitting result based on weights corresponding to the feature dimensions and the feature value corresponding to each feature dimension, and determine, by using the predetermined optimization algorithm, a weight corresponding to each feature dimension, for minimizing a difference between the fitting result and the output result corresponding to the target feature data comprises being caused to:
input the target feature data and the output result corresponding to the target feature data into a predetermined weight determining model, so that the weight determining model determines the fitting result based on the weights corresponding to the feature dimensions and the feature value corresponding to each feature dimension, and determines the weight corresponding to each feature dimension, for minimizing the difference between the fitting result and the output result corresponding to the target feature data.

20. The non-transitory computer-readable storage medium according to claim 9, wherein the processor being caused to determine the fitting result based on weights corresponding to the feature dimensions and the feature value corresponding to each feature dimension, and determine, by using the predetermined optimization algorithm, a weight corresponding to each feature dimension, for minimizing a difference between the fitting result and the output result corresponding to the target feature data comprises being caused to:
determine the fitting result based on the weights corresponding to the feature dimensions and the feature value corresponding to each feature dimension, and determine, by using the predetermined optimization algorithm and based on a correlation between each feature dimensions comprised in the feature data, the weight corresponding to each feature dimension, for minimizing the difference between the fitting result and the output result corresponding to the target feature data.
